(19) United States
(12) Patent Application Publication
(10) Pub. No.: US 2026/0153427 A1
(43) Pub. Date: Jun. 4, 2026

(54) SUPPRESSION ELEMENT FOR FLOW CYTOMETER

(71) Applicant: Beckman Coulter, Inc., Brea, CA (US)

(72) Inventors: Evgenia M. KIM, Palmetto Bay, FL (US); Ernesto STAROSWIECKI, Weston, FL (US)

(73) Assignee: Beckman Coulter, Inc., Brea, CA (US)

(21) Appl. No.: 18/865,214

(22) PCT Filed: May 12, 2023
(86) PCT No.: PCT/US2023/066912

§ 371 Date: Nov. 12, 2024

Related U.S. Application Data
(60) Provisional application No. 63/341,805, filed on May 13, 2022.
(60) Provisional application No. 63/349,274, filed on Jun. 6, 2022.

(51) Int. Cl. G01N 15/1434; G01N 15/00

(52) U.S. Cl. CPC G01N 15/1434; G01N 2015/0038; G01N 2015/145; G01N 2015/1454

(57) ABSTRACT

A detection system for a flow cytometer includes a light source configured to generate an excitation light beam. A suppression element has a first portion having a first characteristic, and a second portion surrounding the first portion. One or more differences between the first and second characteristics cause a phase shift between light fringes and a high intensity core of the excitation light beam resulting in suppression of the light fringes.

This application is being filed on May 12, 2023, as a PCT International Patent application and claims the benefit of and priority to U.S. Provisional patent application Ser. No. 63/341,805, filed May 13, 2022, and U.S. Provisional patent application Ser. No. 63/349,274, filed Jun. 6, 2022, the entire disclosures of which are incorporated by reference herein in their entirety.

### BACKGROUND

In flow cytometry, particles are arranged in a sample stream, and typically pass one-by-one through one or more excitation light beams with which the particles interact. Light scattered or emitted by the particles upon interaction with the one or more excitation beams is collected and analyzed to characterize and differentiate the particles. In a sorting flow cytometer, particles may be extracted out of the sample stream after having been characterized by their interaction with the one or more excitation beams, and thereby sorted into different groups.

Conventional flow cytometers are often suitable for detecting a sample having particles or cells with a size often greater than 1000 nm. However, conventional flow cytometers are not well-suited for detecting very small particles, such as biological nanoparticles (e.g., extracellular vesicles) or non-biological nanoparticles (e.g., nanobeads). For example, many conventional flow cytometers are simply not sensitive enough to detect or discern optical signals from these very small particles, resulting in an inaccurate detection result.

Designing flow cytometers for nanoparticle detection is challenging because light scattering of nanoparticles is orders of magnitude lower than microparticles, which makes the light scattering difficult to detect. One approach for analyzing nanoparticles using flow cytometry is to focus the excitation laser beam more tightly to increase the intensity of the light scatter. However, diffraction fringes appear due to a diffraction limit of the focusing element used to focus the excitation laser beam. The diffraction fringes create an extra noise that is difficult to filter without reducing resolution, making it difficult to accurately detect nanoparticles. Also, quality of the excitation light beam and aberrations from optical components can create additional light fringes in the excitation light beam profile at an interrogation point, which can create further noise and difficulty for detection of nanoparticles.

### SUMMARY

The present disclosure relates to a detection system for a sample processing instrument such as a flow cytometry sorter and/or analyzer, and in particular to a suppression element for the sample processing instrument. Various aspects are described in this disclosure, which include, but are not limited to, the following aspects.

One aspect relates to a detection system, comprising: a light source configured to generate an excitation light beam having a first portion and a second portion; a suppression element having: a first portion having a first characteristic; and a second portion surrounding the first portion, the second portion of the suppression element having a second characteristic causing a phase shift between the first and second portions of the excitation light beam; a focusing lens configured to focus the excitation light beam for high scatter intensity detection of particles; and a light collection unit configured to detect the particles.

Another aspect relates to a suppression element for a flow cytometer configured to detect nanoparticles, the suppression element comprising: a first portion having a first characteristic; and a second portion surrounding the first portion, the second portion having a second characteristic, wherein the second characteristic causes a phase shift between low intensity light fringes and a high intensity core of an excitation light beam.

Another aspect relates to a method of detecting nanoparticles in a flow cytometer, comprising: emitting an excitation light beam having a first portion that includes a high intensity core and a second portion that includes low intensity light fringes; passing the excitation light beam through a suppression element, in which the first portion of the excitation light beam passes through a first portion of the suppression element, and the second portion of the excitation light beam passes through a second portion of the suppression element; focusing the excitation light beam for high scatter intensity detection of nanoparticles; and detecting the nanoparticles having a size of 80 nanometers or less.

### DESCRIPTION OF THE FIGURES

The following drawing figures, which form a part of this application, are illustrative of the described technology and are not meant to limit the scope of the disclosure in any manner.

FIG. 1 schematically illustrates an example of a detection system for detecting and analyzing nanoparticles.

FIG. 2 illustrates an example of a profile and cross-sectional views of an excitation light beam at an interrogation point in the detection system of FIG. 1.

FIG. 3 illustrates another example of a cross-sectional view of an excitation light beam at the interrogation point in the detection system of FIG. 1.

FIG. 4 illustrates an example of a suppression element for use in the detection system of FIG. 1 to reduce and/or eliminate light fringes present in the excitation light beam.

FIG. 5 schematically illustrates an example of a method of suppressing the light fringes in the detection system of FIG. 1.

FIG. 6 schematically illustrates examples of first and second embodiments of the suppression element of FIG. 4.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

An example detection system is described herein for use in a flow cytometry analyzer. It should be understood that the present disclosure is not limited to the illustrated detection system, but may be applied to a flow cytometry analyzer with other structure or other types of detection systems. In particular, the present disclosure can be applied to various types of sample processing instruments for detecting, sorting, or otherwise processing nanoparticles.

Also, the detection system described herein is for detecting nanoparticles, which refer to nanoscale particles. For example, the particles may have a size (for example, a diameter, a maximum size, or an average size) that is less than or equal to 1000 nm (nanometer), especially, a size ranging from 40 nm to 200 nm. The nanoparticles may be biological nanoparticles (e.g., extracellular vesicles) or non-biological nanoparticles (e.g., nanobeads).

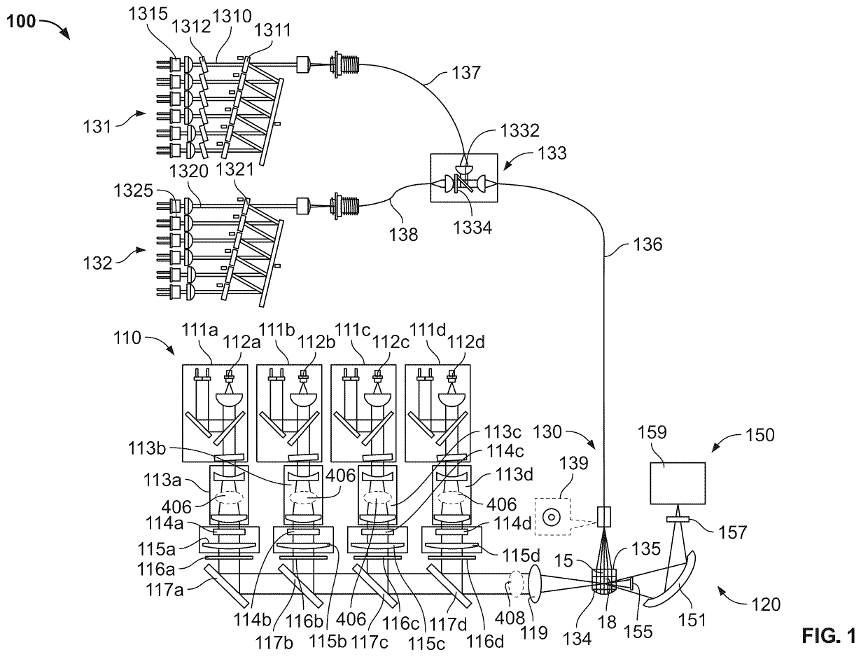

FIG. 1 schematically illustrates an example of a detection system 100 for detecting and analyzing nanoparticles. In accordance with the examples described herein, the detection system 100 can be incorporated into a flow cytometer and/or a sorting flow cytometer. As shown in FIG. 1, the detection system 100 includes a light emitting unit 110, and a light collection unit 120 that detects and/or analyzes nanoparticles that flow through a cuvette 15.

The light emitting unit 110 is configured to emit a light beam and project the light beam onto a nanoparticle flowing through a detection channel 18 of the cuvette 15. The light collection unit 120 is configured to collect light scattered or emitted from the nanoparticles so as to analyze the nanoparticles based on the collected light.

The light emitting unit 110 includes multiple light sources, such as the light sources 111a, 111b, 111c, and 111d shown in FIG. 1. As an illustrative examples, the light sources 111a-111d can include lasers. The light sources 111a to 111d are each configured to emit excitation light beams with different wavelengths, for example, 405 nm, 488 nm, 561 nm, and 638 nm. In the example shown in FIG. 1, the light sources 111a-111d are arranged in parallel. It should be understood that the number, the type, and the arrangement of the light sources are not limited to the example shown and described herein, and may be changed as needed. For example, the system may include three, five, six, or any other suitable number of light sources.

The light emitting unit 110 further includes a focusing lens 119. The excitation light beams emitted by the light sources 111a-111d pass through the focusing lens 119, which focuses the excitation light beams to have the same interrogation point in the detection channel 18 of the cuvette 15. The interrogation point may also be referred to as a focus point where the focused excitation light beams meet the core sample stream in the detection system 100. As will be described in more detail, the focusing lens 119 is configured to focus the excitation light beams for high scatter intensity detection of nanoparticles.

Dichroic mirrors 117a, 117b, 117c, and 117d are arranged between the focusing lens 119 and the respective light sources 111a-111d. Each of the dichroic mirrors 117a-117d is configured to reflect a light beam of a corresponding one of the light sources 111a-111d and transmit the light beams of the other light sources. The dichroic mirrors 117a-117d are selected and configured according to the wavelengths of the light beams emitted by the respective light sources 111a-111d. For example, the dichroic mirror 117b may be configured to reflect light of the wavelength emitted by the light source 111b and configured to transmit light of the wavelength emitted by the light source 111a; the dichroic mirror 117c may be configured to reflect light of the wavelength emitted by the light source 111c and configured to transmit light of the wavelengths emitted by the light sources 111a and 111b; and the dichroic mirror 117d may be configured to reflect light of the wavelength emitted by the light source 111d and configured to transmit light of the wavelengths emitted by the light sources 111a, 111b, and 111c.

The light beams emitted by the light sources 111a-111d are reflected by or transmitted through the dichroic mirrors 117a-117d to form collinear beams. The collinear beams share an optical axis, and provide a confocal point of multiple light sources by focusing on the same interrogation point. The dichroic mirrors 117a-117d are adjustable in their positions or orientations, such that they can be used to adjust the position of the focus point of the light beams, especially, the position on a plane perpendicular to the optical axis. In some examples, the beams may be configured such that they are not collinear, but are convergent beams that still focus on the same point. That is, they may not all have the same optical axis, but they are all configured to focus on a single point in the sample channel of the cuvette 15.

Lenses 115a-115d are arranged between the respective light sources 111a-111d and the respective dichroic mirrors 117a-117d. In some examples, the lenses 115a-115d are long-focus lens. In some examples, the lenses 115a-115d are spherical lenses. In other examples, the lenses 115a-115d are aspheric lenses. Each of the lenses 115a-115d can convert light beams into parallel beams. In the example shown in FIG. 1, each of the lenses 115a-115d is in the form of planoconvex lens with a flat surface and a convex surface opposite to each other. For example, the convex surface of the planoconvex lens may have a focal length of 2400 mm.

The lenses 115a-115d are adjustable in their positions or orientations, so as to adjust the position of the focus point of the light beams, especially, the position on the plane perpendicular to the optical axis. Generally, the dichroic mirrors 117a-117d can be used to roughly adjust the position of the focus point of the light beams, whereas the lenses 115a-115d can be used to finely adjust the position of the focus point of the light beams.

It should be understood that the number, the type, and the arrangement of the dichroic mirrors 117a-117d and the lenses 115a-115d may be changed as needed, and are not limited to the example illustrated herein. Also, the dichroic mirrors 117a-117d and the lenses 115a-115d can be replaced with other optical elements or optical modules with similar functions.

Beam expanders 113a-113d may be arranged between the respective light sources 111a-111d and the respective lenses 115a-115d. Each of the beam expanders 113a-113d can change a sectional dimension and a divergence angle of a light beam. As such, each of the beam expanders 113a-113d are configurable according to a desired size of a spot of a light beam.

The light beams irradiated on the nanoparticles by the focusing lens 119 has a spot size that is smaller than that provided by detection systems in conventional flow cytometers. The smaller spot size allows for more concentrated light beams with a higher power density. This can increase intensity of the light beams irradiated on the nanoparticles, and ultimately the intensity of the optical signals collected from the nanoparticles. This can improve the efficiency of collecting the optical signals, and thereby provide higher resolution and higher sensitivity for nanoparticle detection. For example, the spot size can be about 15×3 μm.

In the example shown in FIG. 1, the light sources 111a-111d are in the form of lasers that include respective laser diodes 112a-112d. As further shown in the example of FIG. 1, half-wave plates 116a-116d are provided between the dichroic mirrors 117a-117d and the lenses 115a-115d, respectively. The spot of the light beam can be reduced by orientation of the light sources 111a-111d and by use of the half-wave plates 116a-116d.

As further shown in FIG. 1, cylindrical lenses 114a-114d are provided between the respective beam expanders 113a-113d and the respective lenses 115a-115d. The horizontal size of the spot of the light beam focused in the cuvette 15 can be adjusted by replacing the cylindrical lenses 114a-114d with replacement cylindrical lenses having different curvatures.

Additionally, or alternatively, the power of some or all of the light sources 111a-111d may be increased, compared with the conventional detection systems. For example, a particular light source of a conventional detection system may have a power of 30 mW, whereas the light sources 111a-111d of the detection system 100 can have an increased power of 50 mW. The increased power of the light sources 111a-111d can also improve detection sensitivity.

Each of the beam expanders 113a-113d is formed of a first optical part and a second optical part. In the example shown in FIG. 1, each of the beam expanders 113a-113d includes a concave lens adjacent to the corresponding light source as the first optical part, and further includes a convex lens away from the corresponding light source as the second optical part. It should be understood that each of the beam expanders 113a-113d is not limited to the example shown in FIG. 1. The beam expanders 113a-113d may be formed of any suitable optical lens or lens group. For example, each of the first optical part and the second optical part can be selected from one of a convex lens, a convex lens group, a concave lens, and a concave lens group.

For each of the beam expanders 113a-113d, the distance between the first optical part (e.g., the concave lens) and the second optical part (e.g., the convex lens) is adjustable. This allows for adjustment of a waist position (the focus point) of the light beam on the optical axis.

As described above, by adjusting the dichroic mirrors 117a-117d, the lenses 115a-115d, and the beam expanders 113a-113d, the individual light beams can be focused at the desired interrogation point, and multiple light beams can be focused at the same interrogation point. It should be understood that the position of the focus point of the light beams may be adjusted by adopting any other optical element or in any other adjustment manner. One or more adjustments to the dichroic mirrors 117a-117d, the lenses 115a-115d, and the beam expanders 113a-113d may be made manually, or may be made electronically using a computing device (e.g., a controller) that is associated with one or more actuators coupled to these components.

The light collection unit 120 includes a side collection part 130 and a forward collection part 150. The side collection part 130 serves as the side scatter unit, which collects side scattered light and fluorescent light scattered or emitted from the nanoparticles in the sample as they are irradiated by the light beams while passing through the cuvette 15. The optical axis of light beams collected from the nanoparticles by the side collection part 130 is approximately perpendicular to, or about 90 degrees, from the optical axis of the light beams emitted from the light sources 111a-111d and directed by the dichroic mirrors 117a-117d toward the cuvette 15.

The forward collection part 150 serves as the forward scatter unit, which collects forward scattered light from the nanoparticles. The optical axis of light beams collected from the nanoparticles by the forward collection part 150 may be approximately parallel to, or about 0 degrees from, the optical axis of the light beams that are directed toward the cuvette 15. The side collection part 130 and the forward collection part 150 are described in further detail below.

The side collection part 130 includes an optical focusing lens group including a concave mirror 134 and an aspheric lens 135, a collection fiber 136, a beam splitter 133, a first wavelength division multiplexer 131, and a second wavelength division multiplexer 132. The concave mirror 134 reflects the scattered light and the fluorescent light that diverge in various directions at the interrogation point. The concave mirror 134 and the aspheric lens 135 focus the reflected light onto the collection fiber 136, for example, by focusing on the same point of the collection fiber 136 as shown in the dotted block 139 in FIG. 1. The concave mirror 134 can focus the reflected light on the fiber, while the aspheric lens 135 can make the focal point smaller (i.e., reduce the aberration). To prevent crosstalk, a beam splitter 133 is arranged to separate the scattered light with high intensity from the fluorescent light with low intensity. The separated scattered light and fluorescent light respectively enter the first wavelength division multiplexer 131 and the second wavelength division multiplexer 132 through first and second fibers 137, 138, respectively. Optical signals with different wavelengths are separated in the first wavelength division multiplexer 131 and the second wavelength division multiplexer 132 for analysis. It should be noted that the optical focusing lens group may adopt other optical elements.

The beam splitter 133 includes a dichroic mirror 1332 and a notch filter 1334. Collected light is directed into the beam splitter toward the dichroic mirror 1132 by the collection fiber 136, which may be oriented such that the light beam is directed toward the dichroic mirror 1332 at an incident angle of, for example, 45 degrees. The dichroic mirror 1332 reflects the side scattered light coming out of the collection fiber 136 such that the side scattered light enters the first wavelength division multiplexer 131 through the first fiber 137.

The fluorescent light coming out of the collection fiber 136 passes through dichroic mirror 1332, and is incident to the notch filter 1334 at an incident angle of about 90 degrees and then passes through the notch filter 1334. The fluorescent light enters the second wavelength division multiplexer 132 through the second fiber 138. The dichroic mirror 1332 and the notch filter 1334 can each have multiple bands according to the confocal design of the light sources 111a-111d. In this case, the dichroic mirror 1332 and the notch filter 1334 both have four bands that block four laser wavelengths. The number of bands of the dichroic mirror 1332 and the notch filter 1334 can correspond to the number of the light sources 111a-111d.

The beam splitter 133 separates the side scattered light with high intensity from the fluorescent light with low intensity, reducing or preventing crosstalk of the side scattered light to the fluorescent light. In addition, by providing the beam splitter, it is possible to separate and transmit multiple light beams into two or more wavelength division multiplexers. Most of the existing wavelength division multiplexers have limited signal channels, for example, six signal channels. In the case of more than six light signals, a single wavelength division multiplexer having six signal channels is insufficient. The use of the existing wavelength division multiplexer may significantly reduce the costs. The optical elements included in the beam splitter 133 and their configuration may be changed, and are not limited to the example shown.

In some examples, the first wavelength division multiplexer 131 may be configured to receive the side scattered light beams from the beam splitter 133 via the first fiber 137 and to divide optical signals of the side scattered light with different wavelengths from each other. In the first wavelength division multiplexer 131, each optical signal is transmitted along an optical transmission path 1310 corresponding to an optical channel of the optical signal. The first wavelength division multiplexer 131 may include a first filter 1311 and a second filter 1312 for each optical channel. The first filter 1311 and the second filter 1312 may be arranged at a certain distance from each other along the optical transmission path of the optical channel in a non-parallel manner. Crosstalk between side scattered lights can be reduced or prevented by providing the two filters. The first and second filters 1311 and 1312 are not arranged in parallel so as to avoid multiple reflections of light between them and achieve a better optical density. Thereafter, the filtered light enters a light detection element 1315 (e.g., a photodiode, an avalanche photodiode (APD), a photomultiplier tube) for further processing the light.

As further shown in the example illustrated in FIG. 1, the second wavelength division multiplexer 132 may be configured to receive a fluorescent beam from the beam splitter 133 via the second fiber 138 and to divide the optical signals of the fluorescent beam having different wavelengths from each other. In the second wavelength division multiplexer 132, each optical signal is transmitted along an optical transmission path 1320 corresponding to an optical channel of the optical signal. Since the fluorescent signal is weak, the second wavelength division multiplexer 132 may include a single filter 1321 for each optical channel. Thereafter, the filtered fluorescent light enters a light detection element 1325 (e.g., a photodiode, an avalanche photodiode (APD), a photomultiplier tube) for further processing the light.

Alternative suitable configurations for the wavelength division multiplexers may be used. For example, the first and second wavelength division multiplexers 131, 132 can include notch filters corresponding to the respective fluorescence channels. The notch filters can reduce or eliminate the crosstalk of the side scattered light to the fluorescence light. In this case, the beam splitter 133 may only include the dichroic mirror 1332 with no notch filter 1334.

In the side collection part 130, a diameter of the collection fiber 136 may be different from diameters of the first fiber 137 and the second fiber 138 according to the light transmission efficiency. Lenses in the beam splitter may cause aberration, and thus the output light spots may be larger than input of the beam splitter, and the fiber diameters may be selected accordingly.

The forward collection part 150 includes an obscuration bar 155, a concave mirror 151, a filter 157, and a forward detector 159. The obscuration bar 155 is configured to block a large portion of the light transmitted through the cuvette 15 to reduce background noise created by light beams that go directly through the cuvette 15, and allow collection of only forward scattered light from the nanoparticles. In some examples, the majority of the transmitted light may be blocked so as not to saturate the forward detector 159. The concave mirror 151 is configured to reflect a forward scattered beam emitted from the nanoparticles. The filter 157 is configured to allow forward scattered light with a high signal-to-noise ratio to pass, and block other light. The forward detector 159 receives the filtered forward scattered light from the filter 157, and processes and analyzes the forward scattered light.

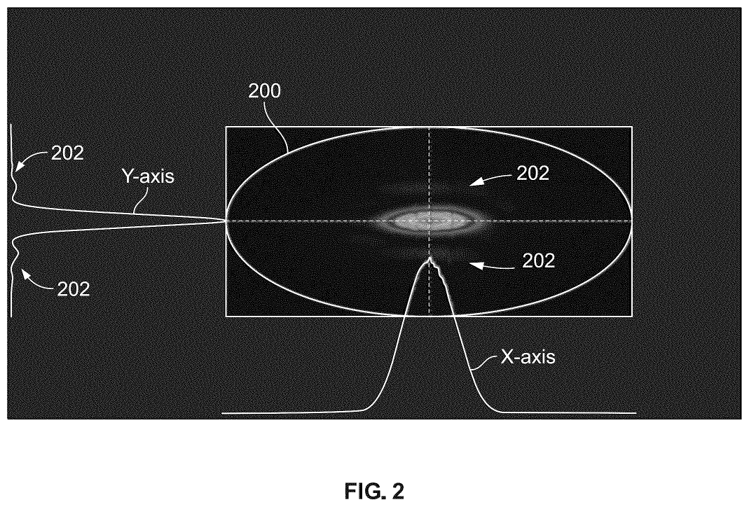

FIG. 2 illustrates an example of a profile and cross-sectional views of an excitation light beam 200 at the interrogation point in the detection system 100. The focusing lens 119 focuses the excitation light beams emitted from the light sources 111a-111d to have a smaller spot size than that provided by conventional detection systems. In this example, the excitation light beam has an approximate spot size of 13.4 μm by 3.5 μm. The smaller spot size can provide higher resolution and higher sensitivity for nanoparticle detection. As shown in FIG. 2, the excitation light beam 200 has a symmetrical Gaussian profile along a horizontal beam cross section (x-axis), but exhibits diffraction fringes 202 along a vertical beam cross-section (y-axis).

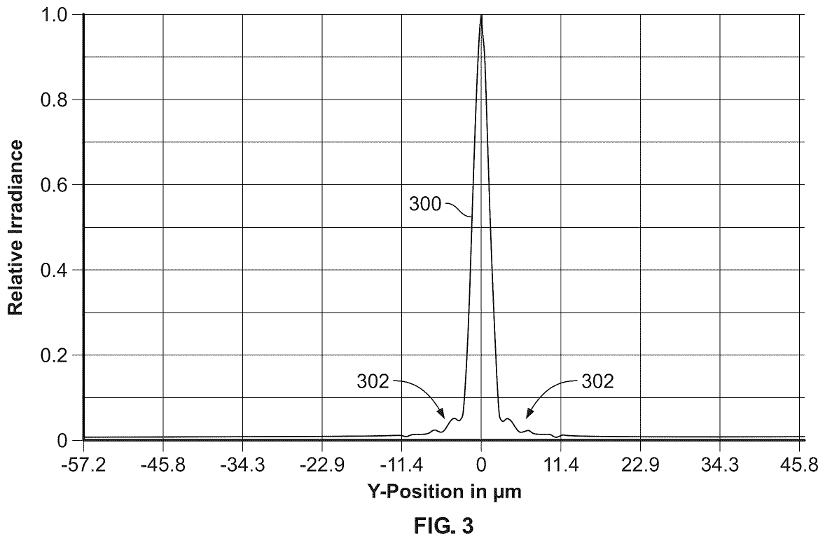

FIG. 3 illustrates another example of a cross-sectional view of an excitation light beam 300 taken along the y-axis at the interrogation point in the detection system 100. In FIG. 3, the excitation light beam 300 similarly shows diffraction fringes 302 along the y-axis. The diffraction fringes 202, 302 shown in FIGS. 2 and 3, respectively, are low intensity ripples of light that result from bending around the edge of the focusing lens 119 instead of going directly through the focusing lens 119. The diffraction fringes can increase beyond a manageable noise level due to the small spot size (about 15×3 μm) that is used by the detection system 100 for detecting nanoparticles. The diffraction fringes are a naturally occurring optical effect due to the diffraction limit of the focusing lens 119.

The diffraction fringes can cause the light collection unit 120 to detect multiple excitations of a single nanoparticle by a light beam emitted from the light emitting unit 110. The multiple excitations can cause the light collection unit 120 to erroneously detect multiple nanoparticles, even though only a single nanoparticle was excited by the light beam. Also, the diffraction fringes have a lower intensity than the core of the excitation light beam 200, 300, which can cause the light collection unit 120 to detect the multiple nanoparticles as having different sizes, even though only a single nanoparticle was excited by the light beam. Thus, the diffraction fringes can cause errors in the detection of nanoparticles by the detection system 100.

In addition to the examples shown in FIGS. 2 and 3, which demonstrate the presence of diffraction fringes due to the diffraction limitation of the focusing lens 119, irregularities of the excitation light beam shape from the Gaussian profile can cause additional light fringes to appear at the interrogation point. Also, aberrations of the one or more optical components in the detection system 100 can cause further light fringes at the interrogation point.

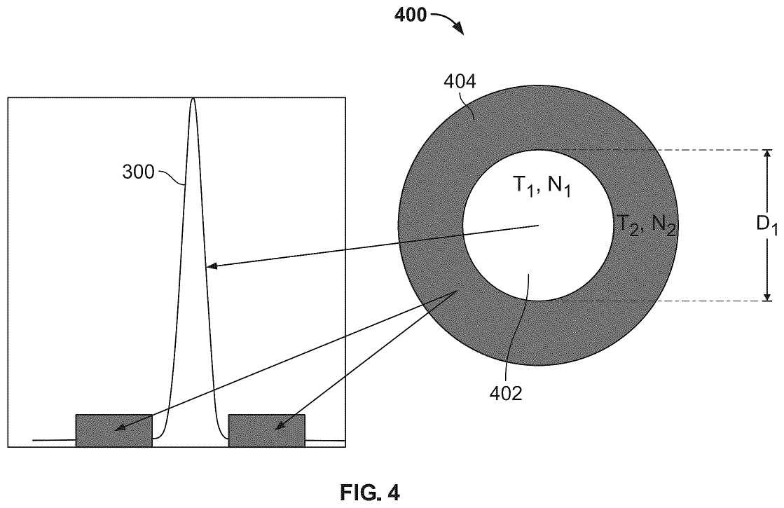

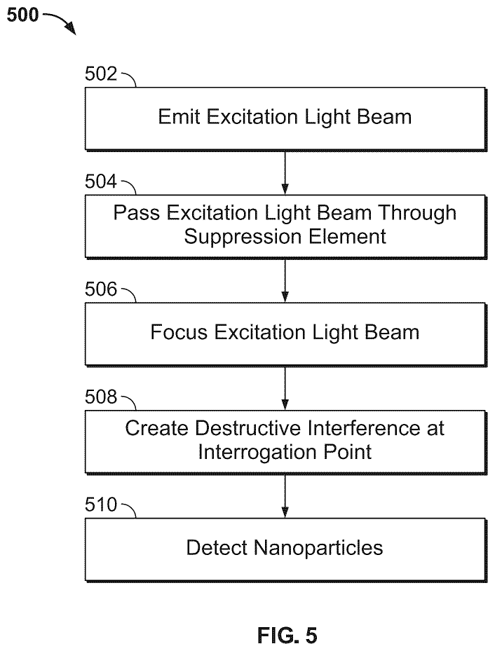

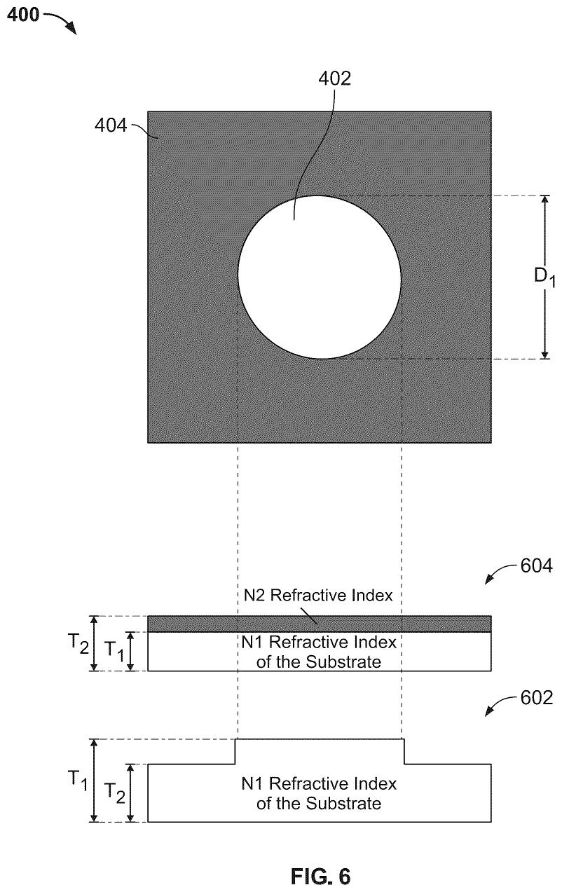

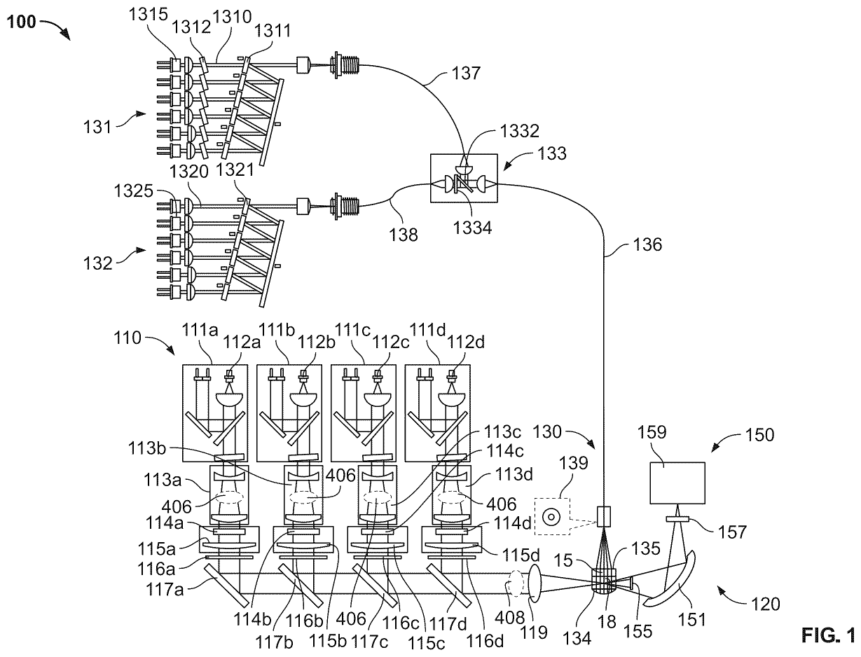

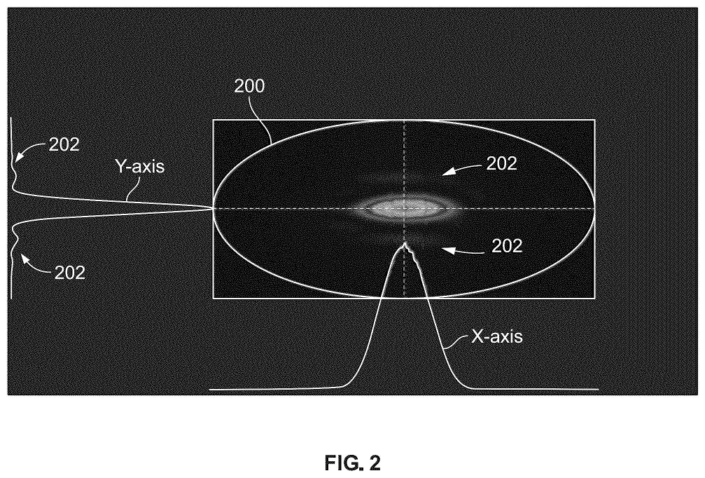

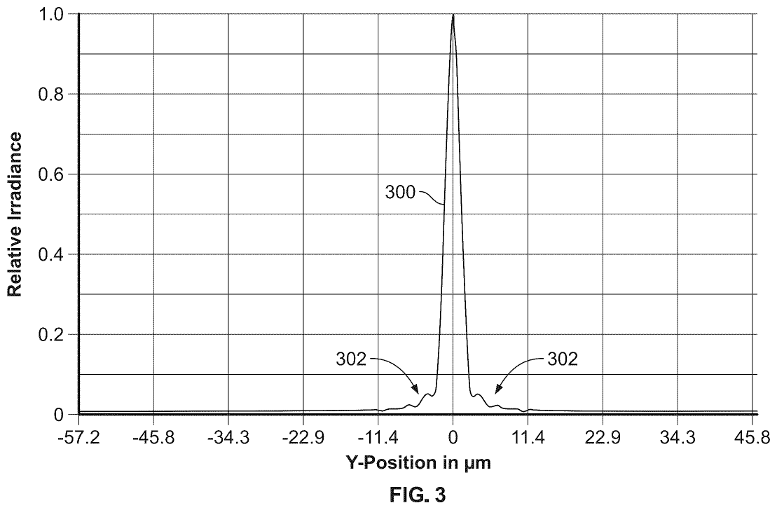

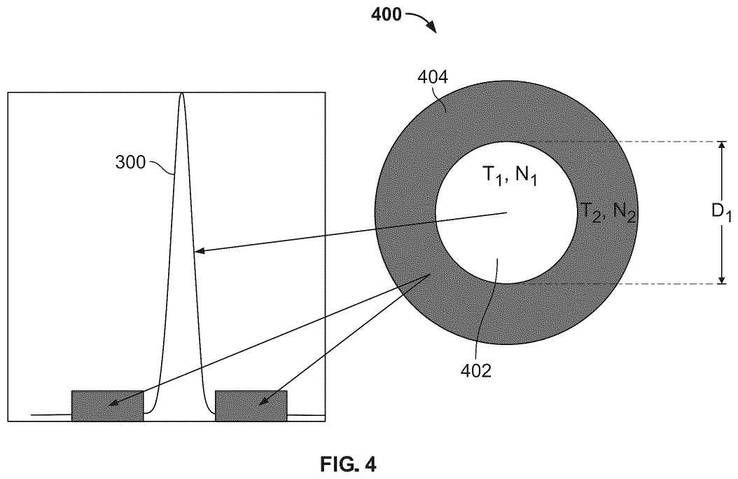

FIG. 4 illustrates an example of a suppression element 400 that is a universal solution in the detection system 100 for suppression of light fringes that can result from the diffraction limit of the focusing lens, imperfection of the excitation light beam shape (e.g., not Gaussian), aberrations from the one or more optical components in the detection system 100, and other possible causes of light fringes at the interrogation point of the detection system 100. In one particular example, the suppression element 400 is used in the detection system 100 to reduce and/or eliminate the diffraction fringes shown in FIGS. 2 and 3.

The suppression element 400 includes a first portion 402, and a second portion 404 surrounding the first portion. The first portion 402 has a first characteristic, and the second portion 404 has a second characteristic that causes a phase shift between two portions of the excitation light beam when both portions of the excitation light beam pass through the suppression element 400. As an illustrative example, a first portion of the excitation light beam having high intensity light passes through the first portion 402, and a second portion of the excitation light beam having low intensity light (e.g., fringes) passes through the second portion 404. At the interrogation point in the detection system 100, both the first and second portions of the excitation light beam interfere with one another to create a destructive interference that suppresses the low intensity light (e.g., fringes) of the second portion of the excitation light beam, and creates maximum contrast between the high intensity light of the first portion and the low intensity light of the second portion of the excitation light beam. By varying the second characteristic of the second portion 404 with respect to the first characteristic of the first portion 402, the suppression element 400 can modulate the intensity of the excitation light beam.

The first portion 402 has an ellipse shape such as an oval shape formed by a closed curve. In the example shown in FIG. 4, the first portion 402 has a circular shape. As further shown in FIG. 4, the first portion 402 has a diameter D1. In some examples, the diameter D1 ranges from about 1 mm to about 5 mm. In some further examples, the diameter D1 ranges from about 2 mm to about 3 mm. It is contemplated that the shape and size of the first portion 402 can be adapted to conform to various shapes of the excitation light beam emitted by the light emitting unit 110. In some examples, the first portion 402 has a substrate thickness ranging from about 0.5 mm to about 1.0 mm. In further examples, the first portion 402 is made of UV fused silica and provides a wavelength coverage of about 350 nm to about 800 nm.

While FIG. 4 shows the second portion 404 as having a ring shape that surrounds the first portion 402, the shape of the second portion 404 may vary. For example, the second portion 404 can have a rectangular or square shape that surrounds the first portion 402.

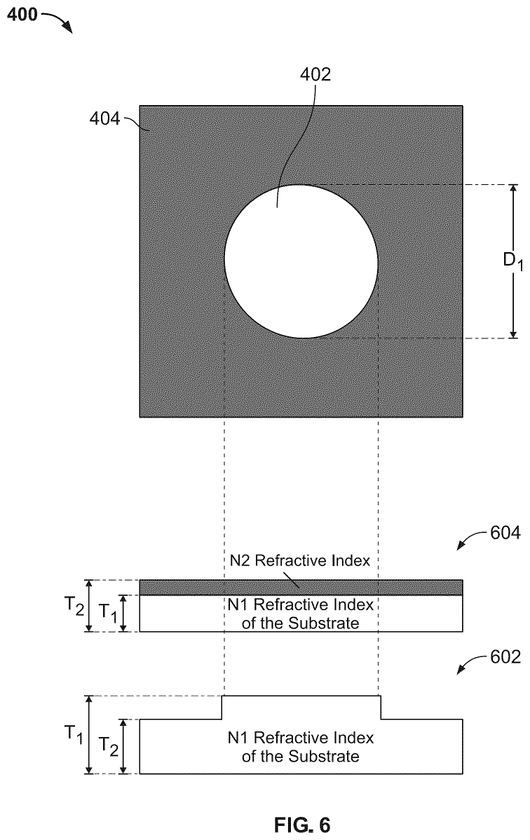

FIG. 6 illustrates a first embodiment 602, in which the first characteristic of the first portion 402 is a first material thickness T₁, and the second characteristic of the second portion 404 is a second material thickness T₂. In the first embodiment 602, the second material thickness T₂ is different from the first material thickness T₁ such that the difference (ΔT=T₁-T₂) causes a phase shift between the high and low intensity portions of the excitation light beam. For example, the high intensity portion of the excitation light beam passes through the first material thickness T₁ of the first portion 402, while the low intensity portion passes through the second material thickness T₂ of the second portion 404, which causes a phase shift between the high and low intensity portions.

The optimal difference (ΔT) between the first material thickness T₁ and the second material thickness T₂ may vary depending on the wavelength of the excitation light beam and refractive index of the first and second portions 402, 404 of the suppression element 400. The phase shift that is generated by the difference between the first material thickness T₁ and the second material thickness T₂ can be determined based on equation (1),

$$Δφ = \frac{2 π}{λ} ( {T}_{1} - {T}_{2} ) N \qquad ( 1 )$$

where Δψ is the phase shift between the high and low intensity portions of the excitation light beam, λ is the wavelength of the excitation light beam, T₁ is the first material thickness, T₂ is the second material thickness, and N is the refractive index of the suppression element 400.

In some examples, the first portion 402 and the second portion 404 are made of the same material. In some examples, the difference (ΔT) between the first material thickness T₁ and the second material thickness T₂ is achieved by etching the suppression element 400 to have the first and second material thicknesses T₁, T₂.

The relative thickness of the first and second material thicknesses T₁, T₂ can vary so long as the first and second material thicknesses T₁, T₂ are different. In the example shown in FIG. 6, the first material thickness T₁ is thicker than the second material thickness T₂. In alternative examples, the second material thickness T₂ can be thicker than the first material thickness T₁.

The difference (ΔT) between the first material thickness T₁ and the second material thickness T₁-T₂ adjusts the optical path or causes a phase shift between the first and second portions of the excitation light beam. In some examples, the difference (ΔT) between the first material thickness T₁ and the second material thickness T₁-T₂ causes a phase shift of π/2 or any odd multiple thereof between the first and second portions of the excitation light beam. For example, the difference (ΔT) between the first material thickness T₁ and the second material thickness T₂ can cause the first and second portions of the excitation light beam to have a phase shift of 3π/2, 5π/2, or 7π/2. The difference (ΔT) between the first and second material thicknesses T₁, T₂ is selected to cause a phase shift that provides a maximum contrast between the low intensity light fringes and the high intensity core of the excitation light beam.

FIG. 6 further illustrates a second embodiment 604, in which the first characteristic of the first portion 402 is a first refractive index N₁, and the second characteristic of the second portion 404 is a second refractive index N₂. In the second embodiment 604, the second refractive index N₂ is different from the first refractive index N¹ such that the difference (AN) causes a phase shift between the high and low intensity portions of the excitation light beam. For example, the high intensity portion of the excitation light beam passes through the first refractive index N₁ of the first portion 402, while the low intensity portion passes through the second refractive index N₂ of the second portion 404, which causes a phase shift between the high and low intensity portions.

The optimal difference (AN) between the first refractive index N₁ and the second refractive index N₂ may vary depending on the wavelength of the excitation light beam and thickness of the second portion 404 having the second refractive index N₂ (e.g., T₂-T₁). The phase shift that is generated by the difference between the first refractive index N₁ and the second refractive index N₂ can be determine based on equation (2),

$$Δφ = \frac{2 π}{λ} ( {N}_{2} - {N}_{1} ) ( {T}_{2} - {T}_{1} ) \qquad ( 2 )$$

where Δ_{ψ} is the phase shift between the high and low intensity portions of the excitation light beam, λ is the wavelength of the excitation light beam, N₂ is the second refractive index of the second portion 404 of the suppression element 400, N₁ is the first refractive index of the first portion 402 of the suppression element 400, T₂ is the second material thickness of the second portion 404 of the suppression element 400 (in the example shown in FIG. 6, T₂ includes a thickness of an evaporated material having the second refractive index N₂ and a thickness of a substrate having the first refractive index N₁), and T₁ is the first material thickness of the first portion 402 of the suppression element 400 in the second embodiment 604 (in the example shown in FIG. 6, T₁ is the thickness of the substrate having the first refractive index N₁). The relative differences between the first and second refractive indices N₁, N₂ can vary so long as the first and second refractive indices N₁, N₂ are different. In some examples, the second refractive index N₂ is higher than the first refractive index N₁. In alternative examples, the second refractive index N₂ is lower than the first refractive index N₁.

In some examples, the first portion 402 and the second portion 404 are made of different materials having different refractive indices. As an illustrative example, the second portion 404 can include one layer or multilayer coatings.

In some examples, the different refractive indices between the first and second portions 402, 404 are obtained by evaporating one or more coatings over the substrate having the thickness T₁ (see example shown in FIG. 6). In some further examples, the different refractive indices are obtained by doping or infusing one or more materials into the substrate having the thickness T₁ to change the relative optical properties and refractive indices of the first and second portions 402, 404 of the suppression element 400.

In some examples, the difference (AN) between the first refractive index N₁ and the second refractive index N₂ causes the first and second portions of the excitation light beam to have an optical path difference or a phase shift of π/2 or any odd multiple thereof. For example, the difference (AN) between the first refractive index N₁ and the second refractive index N₂ can cause the first and second portions of the excitation light beam to have a phase shift of 3π/2, 5π/2, or 7π/2. The difference (ΔN) between the first and second refractive indices N₁, N₂ is selected to cause a phase shift that provides a maximum contrast between the low intensity light fringes and the high intensity core of the excitation light beam.

In some examples, the first characteristic of the first portion 402 is a first combination of material thickness and refractive index, and the second characteristic of the second portion 404 is a second combination of material thickness and refractive index. In such examples, one or more differences between the first and second combinations of material thickness and refractive index (e.g., different material thicknesses, or different refractive indexes, or different combinations of material thicknesses and refractive indexes) cause different optical path lengths for the first and second portions of the excitation light beam, which produce a phase shift that suppresses light fringes of the excitation light beam by destructive interference. In some further examples, the first portion 402 is hollow such that the first portion 402 does not have a material thickness, and the refractive index of the first portion is equivalent to that of air.

In some examples, the first portion 402 of the suppression element 400 defines an aperture and the second portion 404 of the suppression element 400 includes a solid material that surrounds the aperture of the first portion 402. In such examples, the first material thickness T₁ of the first portion 402 is zero, and the second material thickness T₂ can be any value larger than zero. In such examples, the first refractive index N₁ of the first portion 402 is equal to the environment inside of the detection system 100 (e.g., air), and the second refractive index N₂ of the second portion 404 is based on the solid material that surrounds the aperture.

Referring now back to FIG. 1, a suppression element 400 can be positioned in the optical path of each light source 111a-111d between the first and second optical parts of the beam expanders 113a-113d, as shown by first locations 406. Alternatively, a suppression element 400 can be positioned in a common path of the excitation light beams before the focusing lens 119, as shown by a second location 408. In both cases, the first and second locations 406, 408 for placement of the suppression element 400 are before the focusing lens 119 of the detection system 100 to precondition the excitation light beams before they reach the focusing lens 119 to suppress light fringe patterns.

In both embodiments of the suppression element 400 described herein, the first and second portions 402, 404 are transmissible. Accordingly, the second portion 404 of the suppression element 400 is not a physical or mechanical blocker because otherwise it would cause additional light fringe patterns in the excitation light beams transmitted to the interrogation point of the detection system 100.

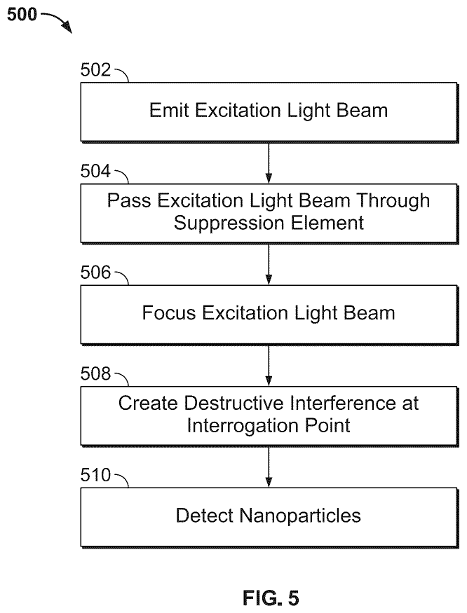

FIG. 5 schematically illustrates an example of a method 500 of detecting nanoparticles in the detection system 100. As shown in FIG. 5, the method 500 includes an operation 502 of emitting an excitation light beam. In accordance with the examples described above, the excitation light beam can be emitted by the light emitting unit 110 in the detection system 100.

Next, the method 500 includes an operation 504 of passing the excitation light beam through the suppression element 400. In accordance with the examples described above, a first portion of the excitation light beam having high intensity light passes through the first portion 402 of the suppression element 400, while a second portion of the excitation light beam having low intensity light (e.g., fringes) passes through the second portion 404 of the suppression element 400. The first characteristic of the first portion 402 and the second characteristic of the second portion 404 cause a phase shift between the low intensity light (e.g., fringes) and the high intensity light of the excitation light beam. In some examples, the phase shift is π/2, or any odd multiple thereof.

In one embodiment, operation 504 produces the phase shift by providing the suppression element 400 with the first portion 402 having the first material thickness T₁, and the second portion 404 having the second material thickness T₂ different from the first material thickness. In this embodiment, the high intensity core of the excitation light beam passes through the first material thickness T₁, and the low intensity light fringes of the excitation light beam pass through the second material thickness T₂.

In another embodiment, operation 504 produces the phase shift by providing the suppression element 400 with the first portion 402 having the first refractive index N₁, and the second portion 404 having the second refractive index N₂ different from the first refractive index. In this embodiment, the high intensity core of the excitation light beam passes through the first refractive index N₁, and the low intensity light fringes of the excitation light beam pass through the second refractive index N₂.

Next, the method 500 includes an operation 506 of focusing the excitation light beam at an interrogation point (e.g., in the detection channel 18 of the cuvette 15) in the detection system 100 for high scatter intensity detection of nanoparticles. In accordance with the examples described above, the excitation light beam can be focused by the focusing lens 119.

Next, the method 500 includes an operation 508 of creating destructive interference at the interrogation point in the detection system 100. The destructive interference results from the phase shift between the first portion of the excitation light beam having high intensity light (which passes through the first portion 402 of the suppression element 400), and the second portion of the excitation light beam having low intensity light fringes (which passes through the second portion 404 of the suppression element 400). The destructive interference suppresses the low intensity light fringes of the second portion of the excitation light beam, and creates maximum contrast between the high intensity light of the first portion and the low intensity light fringes of the second portion of the excitation light beam.

In one illustrative example, the method 500 includes using the suppression element 400 to suppress diffraction fringes in the detection system 100 without loss of resolution from defocusing the excitation light beams emitted from the light emitting unit 110. Instead, the method 500 uses the suppression element 400 to cause a phase shift between the low intensity light fringes and the high intensity core of the excitation light beam, which causes destructive interference between the two portions of the excitation light beam at the interrogation point. This suppresses the low intensity light fringes causing only the high intensity portion of the excitation light beam to scatter light from nanoparticles and thereby reduce errors in nanoparticle detection.

Next, the method 500 includes an operation 510 of detecting nanoparticles from the scatter of the high intensity portion of the excitation light beam. In accordance with the examples described above, the nanoparticles can be detected by the light collection unit 120. In one illustrative example, operation 510 includes detecting nanoparticles having a size (for example, a diameter, a maximum size, or an average size) that is less than or equal to 80 nm.

The various embodiments described above are provided by way of illustration only and should not be construed to be limiting in any way. Various modifications can be made to the embodiments described above without departing from the true spirit and scope of the disclosure.

1. A detection system for a flow cytometer, comprising:
a light source configured to generate an excitation light beam having a first portion and a second portion;
a suppression element having:
a first portion having a first characteristic; and
a second portion surrounding the first portion, the second portion of the suppression element having a second characteristic causing a phase shift between the first and second portions of the excitation light beam;
a focusing lens configured to focus the excitation light beam for high scatter intensity detection of particles; and
a light collection unit configured to detect the particles.

2. The detection system of claim 1, wherein one or more differences between the first characteristic and the second characteristic cause different optical path lengths for the first and second portions of the excitation light beam producing the phase shift that suppresses light fringes of the excitation light beam; and wherein the one or more differences between the first characteristic and the second characteristic cause the phase shift to suppress light fringes of the excitation light beam by destructive interference between the first and second portions of the excitation light beam.

3. (canceled)

4. The detection system of claim 1, wherein the first characteristic is a first material thickness, the second characteristic is a second material thickness, and the second material thickness is different from the first material thickness; or wherein the first characteristic is a first refractive index, the second characteristic is a second refractive index, and the second refractive index is different from the first refractive index.

5. (canceled)

6. The detection system as in claim 1, wherein the phase shift is π/2 or any odd multiple thereof.

7. The detection system as in claim 1, wherein the suppression element is positioned in the optical path of the excitation light beam before the focusing lens.

8. The detection system as in claim 1, wherein the light collection unit detects the particles having a size less than or equal to 80 nanometers.

9. The detection system of claim 1, wherein the first portion of the suppression element defines an aperture, and the second portion of the suppression element includes a solid material that surrounds the aperture of the first portion of the suppression element.

10. A suppression element for a flow cytometer configured to detect nanoparticles, the suppression element comprising:
a first portion having a first characteristic; and
a second portion surrounding the first portion, the second portion having a second characteristic, wherein the second characteristic causes a phase shift between low intensity light fringes and a high intensity core of an excitation light beam.

11. The suppression element of claim 10, wherein one or more differences between the first characteristic and the second characteristic cause different optical path lengths for the first and second portions of the excitation light beam producing the phase shift that suppresses the low intensity light fringes of the excitation light beam.

12. The suppression element of claim 10, wherein the first characteristic is a first material thickness, the second characteristic is a second material thickness, and the second material thickness is different from the first material thickness; wherein the difference between the first material thickness and the second material thickness causes the phase shift that suppresses the low intensity light fringes of the excitation light beam by causing destructive interference with the high intensity core of the excitation light beam; and wherein the first portion and the second portion are made of the same material.

13. (canceled)

14. The suppression element of claim 10, wherein the phase shift is π/2 or any odd multiple thereof.

15. (canceled)

16. The suppression element as in claim 12, wherein the first portion has an ellipse shape; and wherein the first portion has a diameter ranging from about 1 mm to about 5 mm.

17. (canceled)

18. The suppression element of claim 10, wherein the first characteristic is a first refractive index, the second characteristic is a second refractive index, and the second refractive index is different from the first refractive index; and wherein the difference between the first refractive index and the second refractive index causes the phase shift that suppresses the low intensity light fringes of the excitation light beam by causing destructive interference with the high intensity core of the excitation light beam.

19. (canceled)

20. The suppression element of claim 10, wherein the phase shift is π/2 or any odd multiple thereof.

21. The suppression element as in claim 18, wherein the first portion and the second portion include different materials having different optical properties, or wherein the second refractive index of the second portion is provided by infusing a substrate with one or more materials.

22. (canceled)

23. The suppression element as in claim 18, wherein the first portion has an ellipse shape, and wherein the first portion has a diameter ranging from about 1 mm to about 5 mm.

24. (canceled)

25. The suppression element of claim 10, wherein the first portion of the suppression element defines an aperture, and the second portion of the suppression element includes a solid material that surrounds the aperture of the first portion of the suppression element.

26. A method of detecting nanoparticles in a flow cytometer, comprising:
emitting an excitation light beam having a first portion that includes a high intensity core and a second portion that includes low intensity light fringes;
passing the excitation light beam through a suppression element, in which the first portion of the excitation light beam passes through a first portion of the suppression element, and the second portion of the excitation light beam passes through a second portion of the suppression element;
focusing the excitation light beam for high scatter intensity detection of nanoparticles; and
detecting the nanoparticles having a size of 80 nanometers or less.

27. The method of claim 26, wherein a phase shift suppresses the low intensity light fringes of the excitation light beam by causing destructive interference between the first and second portions of the excitation light beam, and wherein the phase shift includes π/2 or any odd multiple thereof.

28. (canceled)

29. The method of claim 27, wherein the phase shift is produced by providing the suppression element with a first material thickness, and a second material thickness different from the first material thickness, and wherein the high intensity core of the excitation light beam passes through the first material thickness, and the low intensity light fringes of the excitation light beam pass through the second material thickness; or providing the suppression element with a first refractive index, and a second refractive index different from the first refractive index, and wherein the high intensity core of the excitation light beam passes through the first refractive index, and the low intensity light fringes of the excitation light beam pass through the second refractive index.

30-31. (canceled)
